(19) United States
(12) Patent Application Publication
(10) Pub. No.: US 2005/0237299 A1
(43) Pub. Date: Oct. 27, 2005

(54) Thumb-controlled keypad

(76) Inventor: Wai Yin Ha, Tseung Kwan O (HK)

Correspondence Address: LEYDIG VOIT & MAYER, LTD, 700 THIRTEENTH ST. NW, SUITE 300, WASHINGTON, DC, 20005-3960, US

(21) Appl. No.: 11/102,772

(22) Filed: Apr. 11, 2005

(30) Foreign Application Priority Data
Apr. 12, 2004 (CN) 200410031130.8
Apr. 12, 2004 (CN) 200420048234.5

(51) Int. Cl. G09G 5/08

(52) U.S. Cl. 345/161

(57) ABSTRACT

A keypad for a portable electronic device, comprises a base, a rod extending from the base and configured to be toggled from a middle position into a plurality of deflected positions and to be depressed from any one of the middle and deflected positions, a number of trigger switches provided on the base and configured to be selectively switched in accordance with the position of the rod to output a corresponding electrical signal to be processed by the portable electronic device.

The present invention relates to a thumb-controlled keypad for use on mobile phones or portable electronic products and an input method therefor.

1. Field of the Invention

More particularly, although not exclusively, the invention relates to a thumb-controlled keypad which performs input by means of a small control rod and an input method therefor.

2. Description of the Prior Art

Mobile phones have become very popular and their uses are expanding. It is common for people to send short messages, however it is very inconvenient to send short messages using the nine-key input method implemented on mobile phones. The main reason is that no matter how the nine keys on the mobile phone are manipulated, it can not be as convenient as a computer keyboard for inputting Chinese and English characters /words. Generally, when Chinese and English are input by using the nine keys, one key must be depressed a number of times to complete the input, and the number of repetitions of each key may vary. The user must look at the key and make considerations so as to complete the input. This is very inconvenient. If a computer keyboard (not excluding a virtual image keyboard) were implemented in a mobile phone or a PDA (Personal Digital Assistant), then the size would have to be excessive. To create a keyboard of sufficiently small size, the keys would have to be so small as to be unusable by ordinarily finger interaction. The user would have to be provided with an additional pressing tool and therefore the speed of input would be slow. For most people use of such an input tool would be unacceptable.

Text and image transfer has become very popular with current communication technologies. For example, 3G mobile phones and PDA technology have entered the market. Many kinds of wireless network application will be indispensable in the future. Therefore, ease of text input for message transfer will become paramount.

### OBJECTS OF THE INVENTION

It is an object of the present invention to overcome or substantially ameliorate at least one of the above disadvantages. It is a further, more general object of the invention to provide a thumb-controlled keypad and an input method of manipulating same.

### SUMMARY OF THE INVENTION

According to the invention, there is provided a keypad for a portable electronic device, comprising:
a base,
a rod extending from the base and configured to be toggled from a middle position into a plurality of deflected positions and to be depressed from any one of the middle and deflected positions,
a plurality of trigger switches provided on the base and configured to be selectively switched in accordance with the toggled position of the rod to thereby output a corresponding electrical signal to be processed by the portable electronic device.

Preferably, said plurality of trigger switches comprises eight said switches corresponding in position to eight said deflected positions of the rod (East, South,West, North, South-East, North-East, South-West, and North-West).

More preferably, the trigger switches are touch-sensitive switches.

Further more preferably, the trigger switches are inductive switches.

Alternatively, the trigger switches are photoelectric switches.

There is further provided herein a mobile phone comprising the above disclosed keypad.

There is further provided herein a PDA comprising the above disclosed keypad.

There is further provided herein an input method using the above disclosed keypad, for generating seventeen different signals corresponding to each of seventeen different positions of the rod.

Preferably, the keypad base comprises another said rod and corresponding set of switches, for generating 34 or more different signals, upon individual manipulation of the rods or combined manipulation thereof, to generate different numerals, letters, or radicals of Chinese characters, or other characters or functions.

More preferably, ten Arabic numerals and some functional keys are indicated by the seventeen different positions of one of the rods.

Further more preferably, the numeral and functional keys correspond to the different actions of the rod in the following manner, in which X indicates that there is an inductive signal, and Reserve indicates other characters or functions:

| | | | | middle | | | | | |
|---|---|---|---|---|---|---|---|---|---|
| | | top- | | (press | | down- | | down- | |
| top-left | top | right | Left | down) | right | left | down | right | representatives |
| X | | | | | | | | | 1 |
| | X | | | | | | | | 2 |
| | | X | | | | | | | 3 |
| | | | X | | | | | | 4 |
| | | | | X | | | | | 5 |
| | | | | | X | | | | 6 |
| | | | | | | X | | | 7 |
| | | | | | | | X | | 8 |
| | | | | | | | | X | 9 |
| X | | | | X | | | | | Yes |
| | | | | | | | | | (OK) |
| | X | | | X | | | | | Reserve |
| | | X | | X | | | | | No |
| | | | | | | | | | (Cancel) |
| | | | X | X | | | | | Reserve |
| | | | | X | X | | | | Reserve |
| | | | | X | | X | | | Reserve |
| | | | | X | | | X | | 0 |
| | | | | X | | | | X | Reserve |

It is preferred that a plurality of alphanumeric characters and some functional keys are indicated by the seventeen different signal outputs of one of the rods, and the seventeen different signals are encoded according to the positions of the alphanumeric characters on a normal keyboard and the correspondence between the toggled directions of one of the rods and the positions.

It is preferred that a plurality of alphanumeric characters and some functional keys are indicated by the thirty four different signal outputs of the two rods, and the thirty four different signals are encoded according to the positions of the alphanumeric characters on a normal keyboard and the correspondence between the toggling directions of a single rod and the positions.

Preferably, the alphanumeric characters and functional keys correspond to the different actions of the rods in the following manner, in which X indicates that there is an inductive signal, and Reserve indicates other characters or functionals:

| top- | | top- | | (press | | down- | | down- | top- | | top- | | (press | | down- | | | repre- |
|---|---|---|---|---|---|---|---|---|---|---|---|---|---|---|---|---|---|---|
| left | top | right | left | down) | right | left | down | right | left | top | right | left | down) | Right | left | down | down-right | sentatives |
| X | | | | | | | | | | | | | | | | | | w |
| | X | | | | | | | | | | | | | | | | | e |
| | | X | | | | | | | | | | | | | | | | r |
| | | | X | | | | | | | | | | | | | | | s |
| | | | | X | | | | | | | | | | | | | | d |
| | | | | | X | | | | | | | | | | | | | f |
| | | | | | | X | | | | | | | | | | | | x |
| | | | | | | | X | | | | | | | | | | | c |
| | | | | | | | | X | | | | | | | | | | v |
| X | | | | X | | | | | | | | | | | | | | q |
| | X | | | X | | | | | | | | | | | | | | Reserve |
| | | X | | X | | | | | | | | | | | | | | t |
| | | | X | X | | | | | | | | | | | | | | a |
| | | | | X | X | | | | | | | | | | | | | g |
| | | | | X | | X | | | | | | | | | | | | z |
| | | | | X | | | X | | | | | | | | | | | Reserve |
| | | | | X | | | | X | | | | | | | | | | b |
| | | | | | | | | | X | | | | | | | | | u |
| | | | | | | | | | | X | | | | | | | | i |
| | | | | | | | | | | | X | | | | | | | o |
| | | | | | | | | | | | | X | | | | | | j |
| | | | | | | | | | | | | | X | | | | | k |
| | | | | | | | | | | | | | | X | | | | l |
| | | | | | | | | | | | | | | | X | | | m |
| | | | | | | | | | | | | | | | | X | | Reserve |
| | | | | | | | | | | | | | | | | | X | Reserve |
| | | | | | | | | | X | | | | X | | | | | y |
| | | | | | | | | | | X | | | X | | | | | Reserve |
| | | | | | | | | | | | X | | X | | | | | p |
| | | | | | | | | | | | | X | X | | | | | h |
| | | | | | | | | | | | | | X | X | | | | Reserve |
| | | | | | | | | | | | | | X | | X | | | n |
| | | | | | | | | | | | | | X | | | X | | Reserve |
| | | | | | | | | | | | | | X | | | | X | Reserve |
| X | | | | | | | | | | | | | X | | | | | W |
| | X | | | | | | | | | | | | X | | | | | E |
| | | X | | | | | | | | | | | X | | | | | R |
| | | | X | | | | | | | | | | X | | | | | S |
| | | | | X | | | | | | | | | X | | | | | D |
| | | | | | X | | | | | | | | X | | | | | F |
| | | | | | | X | | | | | | | X | | | | | X |
| | | | | | | | X | | | | | | X | | | | | C |
| | | | | | | | | X | | | | | X | | | | | V |
| X | | | | X | | | | | | | | | X | | | | | Q |
| | X | | | X | | | | | | | | | X | | | | | Reserve |
| | | X | | X | | | | | | | | | X | | | | | T |
| | | | X | X | | | | | | | | | X | | | | | A |
| | | | | X | X | | | | | | | | X | | | | | G |
| | | | | X | | X | | | | | | | X | | | | | Z |
| | | | | X | | | X | | | | | | X | | | | | Reserve |
| | | | | X | | | | X | | | | | X | | | | | B |
| | | | | X | | | | | X | | | | | | | | | U |
| | | | | X | | | | | | X | | | | | | | | I |
| | | | | X | | | | | | | X | | | | | | | O |
| | | | | X | | | | | | | | X | | | | | | J |
| | | | | X | | | | | | | | | X | | | | | K |
| | | | | X | | | | | | | | | | X | | | | L |
| | | | | X | | | | | | | | | | | X | | | M |
| | | | | X | | | | | | | | | | | | X | | Reserve |
| | | | | X | | | | | | | | | | | | | X | Reserve |
| | | | | X | | | | | X | | | | X | | | | | Y |
| | | | | X | | | | | | X | | | X | | | | | Reserve |
| | | | | X | | | | | | | X | | X | | | | | P |
| | | | | X | | | | | | | | X | X | | | | | H |
| | | | | X | | | | | | | | | X | X | | | | Reserve |
| | | | | X | | | | | | | | | X | | X | | | N |
| | | | | X | | | | | | | | | X | | | X | | Reserve |
| | | | | X | | | | | | | | | X | | | | X | Reserve |

In a preferred embodiment, a plurality of Chinese characters or characters of other languages and some functions are indicated by the thirty four different signal outputs of the two rods, and the thirty four different signals are encoded based on the corresponding positions between these characters and the alphanumeric characters and according to the positions of the alphanumeric characters on a normal keyboard and the correspondence between the toggled directions of one of the rods.

The present invention has the following advantages: It is small-sized, has a fast speed, is convenient and fashionable, and furthermore, it can also b e used by handicapped people. The text input method of controlled rod type can simulate the twenty six main character keys on a keyboard. Only one rod on a mobile phone is required so as to replace 14 main character keys on the mobile phone. Also, in the case where the volume of the mobile phone or PDA is unchanged, the corresponding display screen size can be increased. The design of one rod or two rods, according to the input habits of people, respectively employ the directions of the 11 keys of an analogue standard numeric keypad and the twenty six keys of a standard computer keyboard. For example, when you want to input an A character on the computer keyboard, your left hand will naturally move toward top-left. Thus, we can exploit such a habit and additionally make some exercises, so that the present invention must be the fastest input method for current portable electronic devices. In some inconvenient cases, such designs of one rod or two rods will be very useful. For example, when a driver is driving a car, the 9-keys keypad always requires the user to look in order to perform input, whereas the present invention, comprising a directional input, need not be viewed when used. Further, the designs of one rod or two rods are also suitable for some handicapped persons such as the blind.

### BRIEF DESCRIPTION OF DRAWINGS

The invention will now be more particularly described, by way of example only, with reference to the accompanying drawings, in which:

FIG. 1 is a schematic diagram of an embodiment of a one thumb-controlled rod in accordance with the invention, illustrating toggle and press signals;

FIG. 2 is a triggering schematic diagram of a touch-sensitive switch which generates 17 signals after the thumb-controlled rod of FIG. 1 is toggled;

FIG. 3 is a triggering schematic diagram of an inductive switch which generates 17 signals after the thumb-controlled rod of FIG. 1 is toggled;

FIG. 4 is a position diagram of the eight directions in which the trigger switch of FIGS. 2 and 3 is triggered viewed in top,

FIG. 5 is a schematic diagram of a trigger signal output of the thumb-controlled rod of FIG. 1;

FIG. 6 shows the connection relations among a single thumb-controlled rod of FIG. 1 and relevant electronic elements as well as a processing unit;

FIG. 7 shows a numeral input method of a single thumb-controlled rod of FIG. 1; and

FIGS. 8a and 8b show a text input method of two thumb-controlled rods of FIG. 1.

### DETAILED DESCRIPTION OF PREFERRED EMBODIMENT

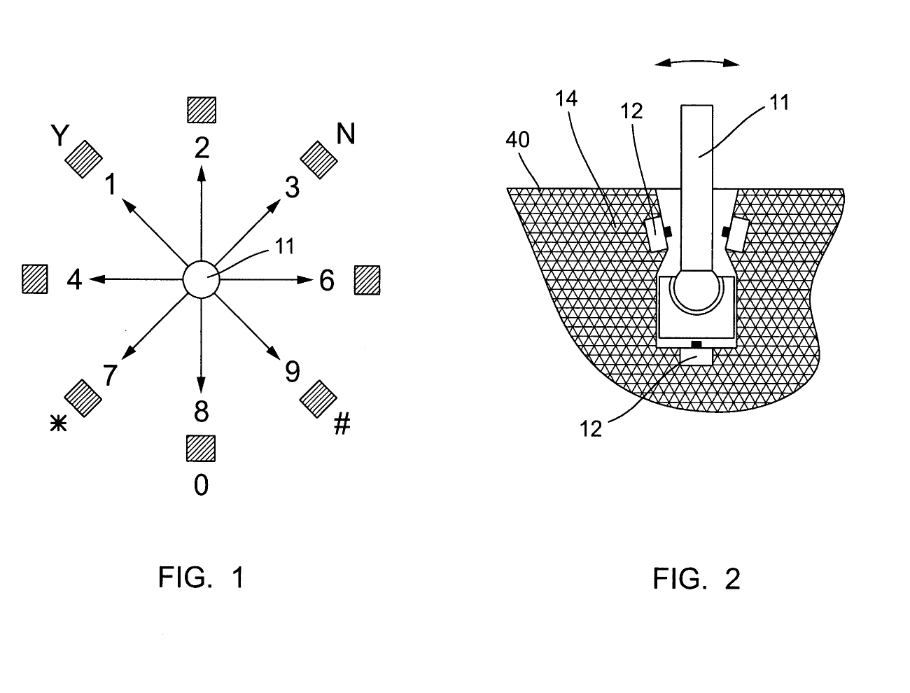

Referring initially to FIG. 1 of the drawings, for a mobile phone or PDA keypad, there is shown one thumb-controlled rod 11 embodying the invention, which can be used to replace a plurality of input keys. The thumb-controlled rod 11 can be toggled in eight directions around it, which are respectively denoted as East, South, West, North, South-East, North-East, South-West, and North-West. After being toggled into a position, the rod 11 can be also pressed successively.

As shown in FIG. 2, a keypad base 14 of the rod 11 is configured to have one touch-sensitive switch 12 in each corresponding direction. In the position connecting the bottom of the rod 11 and the keypad base 14, there is provided one touch-sensitive switch 12. After the rod 11 is toggled into one direction, the touch-sensitive switch 12 for the press of the direction is triggered so as to generate a corresponding electrical signal, and after being confirmed, the rod 11 returns to a zero position, i.e. a position where no switch 12 is triggered, and the electrical signal becomes active. After the rod 11 is toggled into one direction and the switch 12 in that direction is triggered, one electrical signal is generated, and then the rod 11 is pressed down so as to trigger the touch-sensitive switch 12 located at the bottom of the rod 11, thus another electrical signal is generated, and after being confirmed, the rod 11 returns to the zero position, and the electrical signals become active. When the rod 11 is pressed down at the middle position, the touch-sensitive switch 12 of that position is also triggered so as to generate a corresponding electrical signal. Thus, due to the various actions of each rod 11, seventeen different electrical signals can be output.

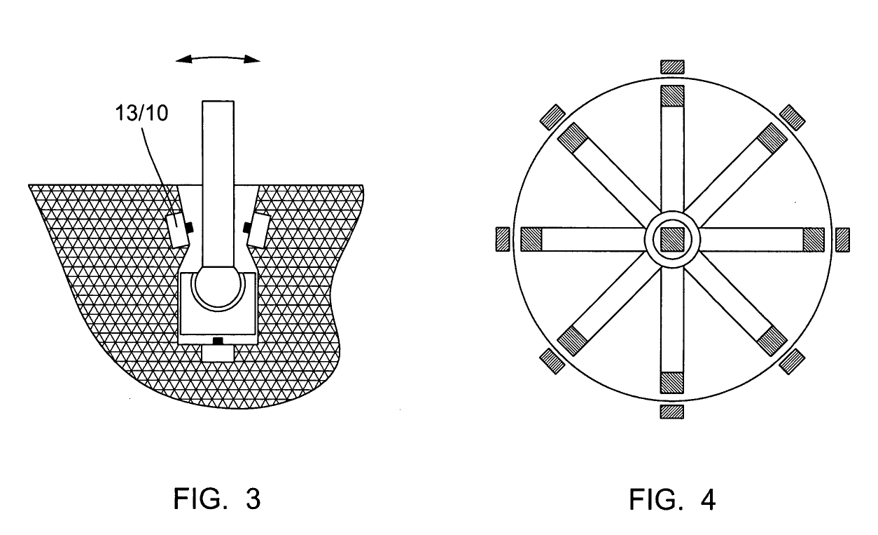

FIG. 3 is a triggering schematic diagram of an inductive switch 13 which generates 17 signals after the thumb-controlled rod 11 as shown in FIG. 1 is toggled. There is provided one inductive switch 13 on the keypad base 14 in each corresponding direction, and one inductive switch 13 also provided at the bottom of the rod 11 on the keypad base 14. At the middle and bottom parts of the rod 11, one switch inductive region is provided respectively. After the rod 11 is toggled into one direction, the inductive region located at the middle part of the rod 11 and the inductive switch 13 of that direction mutually induce so that an electrical signal is generated, and after being confirmed, the rod 11 returns to a zero position, i.e. a position where no switch 13 is triggered, and the electrical signal becomes active. After the rod 11 is toggled into one direction, one electrical signal is generated, and then the rod 11 is pressed down so that the inductive switch 13 located at the bottom of the rod 11 is triggered, thus another electrical signal is generated simultaneously, and after being confirmed, the rod 11 returns to the zero position, and the electrical signals become active. When the rod 11 is pressed down at the middle position, the inductive switch 13 of that position can also generate a corresponding electrical signal. Thus, due to the various actions of each rod 11, seventeen different electrical signals can be output. No matter which orientations (including the zero position) the rod 11 is toggled into, it can be pressed down. Of course, photoelectric switches 10 can be also provided in respective orientations so as to cooperate with the various actions of the rod 11 to generate various electrical signals.

FIG. 4 is a position diagram of the eight directions in which the trigger switches 12/13 are triggered viewed in top. As can be seen in FIG. 4, no matter which triggering way is employed, each rod 11 can always generate seventeen different electrical signals.

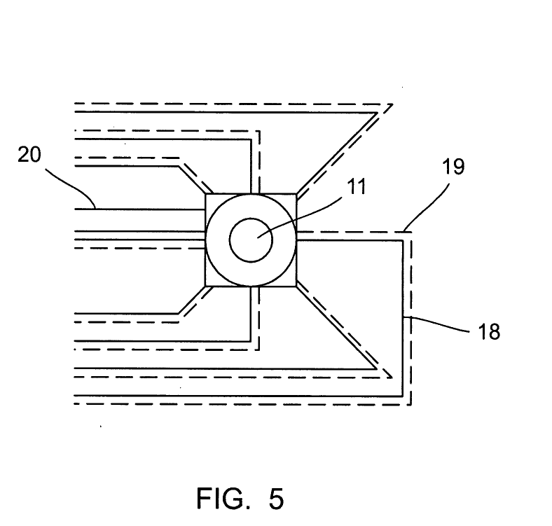

FIG. 5 is a schematic diagram of a trigger signal output of the rod 11. The seventeen different signals of the rod 11 as described above are output. In this figure, the solid lines 18 indicate the electrical signals output lines after the trigger switches 12/13 in respective orientations are triggered, the dotted lines 19 indicate the electrical signals output lines after the trigger switches 12/13 below respective orientations are triggered, and the bold solid lines 20 indicate grounded lines or power supply lines so as to achieve the circuits of electrical signals. The seventeen different signals can be digital signals of 0 or 1 indicated by different voltages. When the rod 11 triggers one or two of the switches 12/13 so that signals are output, the output signals may be 0 or 1. The signal of 0 or 1 can indicate it is triggered or is not triggered. When a triggered signal output of 0indicates it is triggered, the bold solid lines 20 are used as the power supply lines, and the voltages of the power supply lines 20 may be different; and when a triggered signal output of 1 indicates it is triggered, the bold solid lines 20 are used as the grounded lines, and the voltage of the signal lines 18 and 19 may be different.

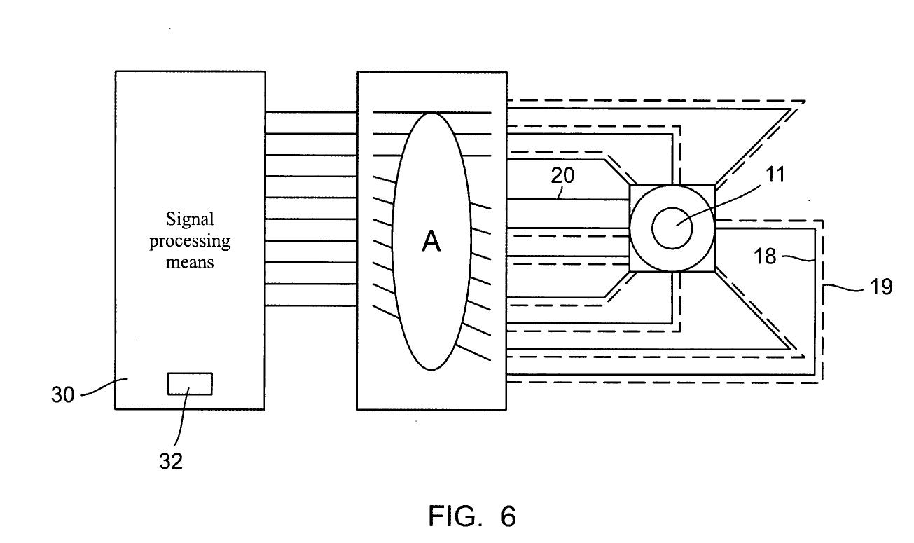

FIG. 6 shows the connection relations among a single rod 11 and relevant electronic elements as well as a processing means 30. In FIG. 6, an area A denotes a variable area connection, all the outputs of the rod 11 can or can not be connected to the area A. There may be a resistor, a capacitor, a row of resistors, an IC, or other relevant electronic elements in the area A. After passing through the area A, all the outputs of the signal lines 18 and 19 are connected to the processing means 30 of the portable electronic device. The number of the output lines passing through the area A may be changed. If the bold solid lines 20 in FIG. 5 which may be the grounded lines or the power supply lines are the power supply lines, these lines can not be connected to the processing means directly or indirectly; whereas if they are the grounded lines, generally, they will be connected to the processing means 30 directly or indirectly.

Only the connections in the case of one rod 11 are shown in FIG. 6. If two rods 11 are employed, all of the output electrical signal lines are connected to one processing means 30, and which may be connected to two areas A simultaneously.

The processing means 30 may employ any technical solution of the prior art and can include an A/D conversion means, an interface circuit, a storage unit and a processing unit 32, etc. The module type of the processing unit 32 may be MCU (RISC, CISC . . . etc), CPU, Computer Control Board, PLC, Logic unit, IC, PAL, GAL . . . and so on.

The main function of the processing unit module 32 is to process the electrical signals directly or indirectly output by the rod 11.

Next, the processing method of the processing unit 32 will be described.

The processing unit 32 may apply the methods of mapping, logic analysis and conditional analysis for processing signal inputs, and after processing, can obtain a desired result.

The processing unit 32 performs logic operation or programming on all the input signals, and uses encoding to set the correspondence between the signals and the displayed characters. When a user starts to toggle the rod 11, according to the principle of the state machine, the logic or program enters into “a state in which a user is performing input”. When the rod 11 returns to the zero position, all the signals are still not triggered, a predetermined logic or program can confirm the last input, and according to the concrete encoding, display a corresponding character on a display. When the user continues to press down the rod 11 after toggling it, one signal is generated due to the toggle, and the other signal is generated due to the press, that is two signals are generated at the same time, after confirming, the user releases the rod 11, and the rod 11 returns to the zero position, at this time, there is no trigger, and these two-times input signals are confirmed in accordance with a predetermined logic or program, and according to the concrete encoding, a corresponding character is displayed on the display. Before the user releases the rod 11, that is, before the rod 11 returns to the zero position, the display position for character selecting can only display the characters or numerals corresponding to those generated after just returning the zero position. The user can make any change. Only when the user makes the rod 11 return the zero position, the display position will display the characters or numerals just input.

The method of mapping can be a table mapping. In a table, it can be defined that different signal inputs are mapped to particular characters representatives so as to achieve a corresponding result. It is shown in the following table.

| | | | | middle | | | | | |
|---|---|---|---|---|---|---|---|---|---|
| | | | | (press | | down- | | down- | |
| top-left | top | top-right | left | down) | right | left | down | right | representatives |
| | | | X | X | | | | | A |
| | | | | X | | | | | D |
| | | | | | X | | | | F |
| | | X | | X | | | | | T |
| X | | | | | | | | | W |

Other cases are omitted herein.
where X indicates that there is an inductive signal.

where X indicates that there is an inductive signal.

The above is but one example of the mapping.

When one rod 11 is used, there is only one mapping table, whereas when two rods 11 are used, the mapping table can be changed somewhat so as to comply with each other.

The logic analysis generally uses logic gates such as AND, OR, NOT or programming to process. One example is shown as follow:

[image]

The above is but one example where a desire character is obtained by using the logic operation method.

The conditional analysis generally performs relevant conditional analyses by using the programs accepted by relevant processing modules. The programs may be different tools or languages such as C/C++, VB, Java, Assemble, macro . . . , etc.

For example, if ((there is an induction in top-right) and (there is an induction in down-middle)) character=T.

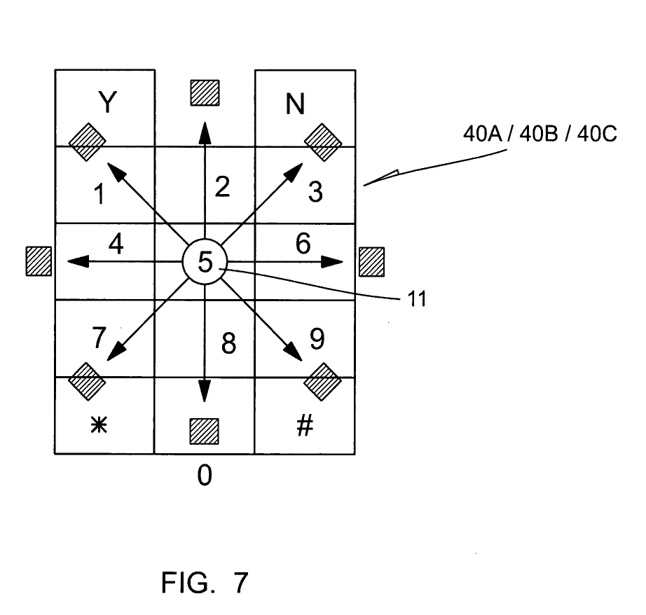

FIG. 7 shows a numeral input method of a single rod 11. The numeral input method of one rod 11 totally sets ten signal inputs, and the remaining can be arbitrarily set, the main numeral inputs are arranged as follows.

If the rod 11 is moved toward top-left (North-West), it is 1; if the rod 11 is moved upwards (North), it is 2; if the rod 11 is moved toward top-right (North-East), it is 3; if the rod 11 is moved toward left (West), it is 4; if the rod 11 is not moved but pressed down once (pressed once at the zero position), it is 5; if the rod 11 is moved toward right (East), it is 6; if the rod 11 is moved toward down-left (South-West), it is 7; If the rod 11 is moved downwards (South), it is 8; and if the rod 11 is moved toward down-right (South-East) and pressed down once, it is 0. The others can be arbitrarily set, for example, if the rod 11 is moved toward top-left and then pressed down, it means “Y”. The time for the confirmation of the signal is when the rod 11 returns the zero position.

The concrete encoding method of a complete thumb-controlled keypad indicated by the seventeen different signals of one rod 11 is shown below.

1. Indications of numeral input keypad 40A (FIG. 7) are shown in the following table:

| | | | | middle | | down- | | down- | |
|---|---|---|---|---|---|---|---|---|---|
| Top-left | top | Top-right | left | (press | right | left | down | right | representatives |
| X | | | | | | | | | 1 |
| | X | | | | | | | | 2 |
| | | X | | | | | | | 3 |
| | | | X | | | | | | 4 |
| | | | | X | | | | | 5 |
| | | | | | X | | | | 6 |
| | | | | | | X | | | 7 |
| | | | | | | | X | | 8 |
| | | | | | | | | X | 9 |
| X | | | | X | | | | | Yes (OK) |
| | X | | | X | | | | | Reserve |
| | | X | | X | | | | | No |
| | | | | | | | | | (Cancel) |
| | | | X | X | | | | | Reserve |
| | | | | X | X | | | | Reserve |
| | | | | X | | X | | | Reserve |
| | | | | X | | | X | | 0 |
| | | | | X | | | | X | Reserve |

2. Indications of alphabet input keypad 40B (FIG. 7) are shown in Table 1 below (the uppercase and lowercase of an English letter are the same):

| | | | | middle | | | | | |
|---|---|---|---|---|---|---|---|---|---|
| | | | | (press | | | | down- | |
| top-left | top | top-right | left | down) | right | down-left | down | right | Representatives |
| X | | | | | | | | | W |
| | X | | | | | | | | E |
| | | X | | | | | | | R |
| | | | X | | | | | | S |
| | | | | X | | | | | D |
| | | | | | X | | | | F |
| | | | | | | X | | | X |
| | | | | | | | X | | C |
| | | | | | | | | X | V |
| X | | | | X | | | | | Q |
| | X | | | X | | | | | Reserve |
| | | X | | X | | | | | T |
| | | | X | X | | | | | A |
| | | | | X | X | | | | G |
| | | | | X | | X | | | Z |
| | | | | X | | | X | | Reserve |
| | | | | X | | | | X | B |

3. Indications of alphanumeric input keypad 40C (FIG. 7) are shown in Table 2 below (the uppercase and lowercase of an English letter are the same):

| | | | | middle | | | | | |
|---|---|---|---|---|---|---|---|---|---|
| | | top- | | (press | | down- | | down- | |
| top-left | Top | right | left | down) | right | left | down | right | Representatives |
| X | | | | | | | | | U |
| | X | | | | | | | | I |
| | | X | | | | | | | O |
| | | | X | | | | | | J |
| | | | | X | | | | | K |
| | | | | | X | | | | L |
| | | | | | | X | | | M |
| | | | | | | | X | | Reserve |
| | | | | | | | | X | Reserve |
| X | | | | X | | | | | Y |
| | X | | | X | | | | | Reserve |
| | | X | | X | | | | | P |
| | | | X | X | | | | | H |
| | | | | X | X | | | | Reserve |
| | | | | X | | X | | | N |
| | | | | X | | | X | | Reserve |
| | | | | X | | | | X | Reserve |

For the above character keypad, the uppercase or lowercase of the character is determined by other signals, the correspondence of the character itself need not be changed.

The “Reserve” in the tables means it can by used for other purpose, for example, it can be used for the determination of the uppercase or lowercase of the letters, such as Caps Lock, Shift, or can be used as mode switch for alphabetic keypad, numeric keypad and other keypad, or can be used for other functions such as Space bar, other punctuation, or Enter and so on.

Certainly, the present invention emphasises the corresponding method of twenty six letters.

The above positions correspond to the positions of the English letters on a common keyboard. If a Chinese or Japanese character, or a character of other languages is needed to be input, the correspondence is based on the corresponding positions on the keyboard between the English letters and these different input characters.

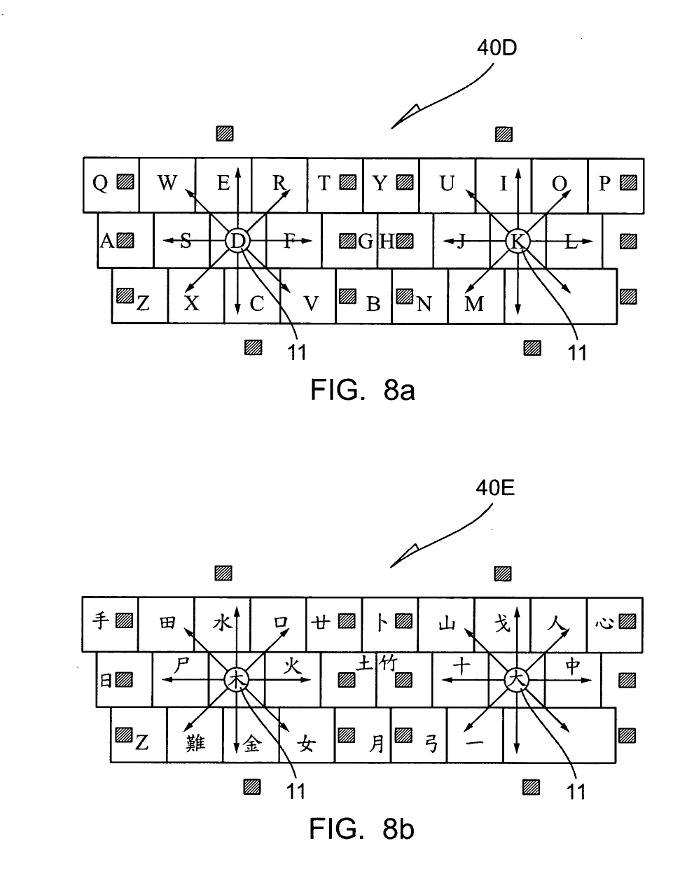

FIG. 8a and FIG. 8b show a text input method of two rods 11. It is conceived by simulating the position arrangement on a computer keyboard. The arrangement by using two rods 12 for simulation is as follows.

There are twenty six character inputs in total on a keyboard (as for English, they are from A to Z, as for Chinese CangJie input characters. They are from [symbol] to [symbol] and so on). Most of character and text input method (including English, simplified Chinese, traditional Chinese, Japanese, French . . . ) are all arranged within the keyboard for A to Z. In these figures, only the arrangements for English alphabet inputs 40D and CangJie character inputs 40E on the two rods 11 are shown, and they are arranged according to the standard character positions for an English keyboard. All the key arrangements for the character input methods of different languages are within the scope of the present invention, for example, the key arrangements for all the input methods of simplified Chinese (such as Wu Bi grapheme input method), the key arrangements for all the input methods of traditional Chinese, . . . , etc. The embodiment in FIGS. 8a and 8b mainly shows the arrangements of the twenty six keys, in which the left rod supplies 15 of them, and the right rod supplies 11 of them, and the remaining 8 representatives can be arbitrarily arranged, for example, they can be used as “Enter”, “SPACE BAR”, “SHIFT”, “,”, “.” and so on.

Hereunder, the mainly thirty four different signal representatives and other signal representatives for two rods input method are shown.

Two thumb-controlled rods 11 are used at the same time, which mainly integrates the alphanumeric keypad 40C representatives of the single thumb-controlled rod 11 as described above wherein Table 1 and Table 2 correspond to left hand and right hand input characters respectively. The two rods 11 are respectively provided on left and right sides.

The encoding method of the character keypads 40B and 40C for two rods 11 are shown in the following table. (The first 9 columns indicate the left-side rod 11, and the next 9 columns indicate the right-side rod 11.)

| | | | | middle | | | | | | | | | middle | | | | | |
|---|---|---|---|---|---|---|---|---|---|---|---|---|---|---|---|---|---|---|
| top- | | top- | | (press | | down- | | down- | top- | | top- | | (press | | down- | | down- | repre- |
| left | top | right | Left | down) | Right | left | down | right | left | top | right | left | down) | right | left | down | right | sentatives |
| X | | | | | | | | | | | | | | | | | | w |
| | X | | | | | | | | | | | | | | | | | e |
| | | X | | | | | | | | | | | | | | | | r |
| | | | X | | | | | | | | | | | | | | | s |
| | | | | X | | | | | | | | | | | | | | d |
| | | | | | X | | | | | | | | | | | | | f |
| | | | | | | X | | | | | | | | | | | | x |
| | | | | | | | X | | | | | | | | | | | c |
| | | | | | | | | X | | | | | | | | | | v |
| X | | | | X | | | | | | | | | | | | | | q |
| | X | | | X | | | | | | | | | | | | | | Reserve |
| | | X | | X | | | | | | | | | | | | | | t |
| | | | X | X | | | | | | | | | | | | | | a |
| | | | | X | X | | | | | | | | | | | | | g |
| | | | | X | | X | | | | | | | | | | | | z |
| | | | | X | | | X | | | | | | | | | | | Reserve |
| | | | | X | | | | X | | | | | | | | | | b |
| | | | | | | | | | X | | | | | | | | | u |
| | | | | | | | | | | X | | | | | | | | i |
| | | | | | | | | | | | X | | | | | | | o |
| | | | | | | | | | | | | X | | | | | | j |
| | | | | | | | | | | | | | X | | | | | k |
| | | | | | | | | | | | | | | X | | | | l |
| | | | | | | | | | | | | | | | X | | | m |
| | | | | | | | | | | | | | | | | X | | Reserve |
| | | | | | | | | | | | | | | | | | X | Reserve |
| | | | | | | | | | X | | | | X | | | | | y |
| | | | | | | | | | | X | | | X | | | | | Reserve |
| | | | | | | | | | | | X | | X | | | | | p |
| | | | | | | | | | | | | X | X | | | | | h |
| | | | | | | | | | | | | | X | X | | | | Reserve |
| | | | | | | | | | | | | | X | | X | | | n |
| | | | | | | | | | | | | | X | | | X | | Reserve |
| | | | | | | | | | | | | | X | | | | X | Reserve |
| X | | | | | | | | | | | | | X | | | | | W |
| | X | | | | | | | | | | | | X | | | | | E |
| | | X | | | | | | | | | | | X | | | | | R |
| | | | X | | | | | | | | | | X | | | | | S |
| | | | | X | | | | | | | | | X | | | | | D |
| | | | | | X | | | | | | | | X | | | | | F |
| | | | | | | X | | | | | | | X | | | | | X |
| | | | | | | | X | | | | | | X | | | | | C |
| | | | | | | | | X | | | | | X | | | | | V |
| X | | | | X | | | | | | | | | X | | | | | Q |
| | X | | | X | | | | | | | | | X | | | | | Reserve |
| | | X | | X | | | | | | | | | X | | | | | T |
| | | | X | X | | | | | | | | | X | | | | | A |
| | | | | X | X | | | | | | | | X | | | | | G |
| | | | | X | | X | | | | | | | X | | | | | Z |
| | | | | X | | | X | | | | | | X | | | | | Reserve |
| | | | | X | | | | X | | | | | X | | | | | B |
| | | | | X | | | | | X | | | | | | | | | U |
| | | | | X | | | | | | X | | | | | | | | I |
| | | | | X | | | | | | | X | | | | | | | O |
| | | | | X | | | | | | | | X | | | | | | J |
| | | | | X | | | | | | | | | X | | | | | K |
| | | | | X | | | | | | | | | | X | | | | L |
| | | | | X | | | | | | | | | | | X | | | M |
| | | | | X | | | | | | | | | | | | X | | Reserve |
| | | | | X | | | | | | | | | | | | | X | Reserve |
| | | | | X | | | | | X | | | | X | | | | | Y |
| | | | | X | | | | | | X | | | X | | | | | Reserve |
| | | | | X | | | | | | | X | | X | | | | | P |
| | | | | X | | | | | | | | X | X | | | | | H |
| | | | | X | | | | | | | | | X | X | | | | Reserve |
| | | | | X | | | | | | | | | X | | X | | | N |
| | | | | X | | | | | | | | | X | | | X | | Reserve |
| | | | | X | | | | | | | | | X | | | | X | Reserve |

The following input encoding method embodiment for two rods can be used to denote other character keys
or functional keys.

| | | | | | | | | | | | |
|---|---|---|---|---|---|---|---|---|---|---|---|
| X | | | | | | | | | X | | Reserve |
| | X | | | | | | | | X | | Reserve |
| | | X | | | | | | | X | | Reserve |
| | | | X | | | | | | X | | Reserve |
| | | | | X | | | | | X | | Reserve |
| | | | | | X | | | | X | | Reserve |
| | | | | | | X | | | X | | Reserve |
| | | | | | | | X | | X | | Reserve |
| | | | | | | | | X | X | | Reserve |
| X | | | | X | | | | | X | X | Reserve |
| | X | | | X | | | | | X | X | Reserve |
| | | X | | X | | | | | X | X | Reserve |
| | | | X | X | | | | | X | X | Reserve |
| | | | | X | X | | | | X | X | Reserve |
| | | | | X | | X | | | X | X | Reserve |
| | | | | X | | | X | | X | X | Reserve |
| | | | | X | | | | X | X | X | Reserve |

The other combinations can not be enumerated one by one, but can all be used as reserved.

For the representatives corresponding to the representatives in the above character keypad 40C with two rods 11, the uppercase or lowercase of the character is determined by other rod signals. The “Reserve” in the tables means it can by used for other purpose, for example, it can be used for the determination of the uppercase or lowercase of the letters, such as Caps Lock, Shift, or can be used as mode switch for alphabet keypad, numeric keypad and other keypad, or can be used as other representatives such as Space bar, other punctuations or Enter and so on.

The left-side rod 11 mainly corresponds to the characters on the left of a normal keyboard, and the right-side rod mainly corresponds to the characters on the right of a normal keyboard.

The correspondence can have the correspondence of the input signals by simultaneously operating the two rods 11, since in terms of the designs of the rods 11, one rod 11 can input at most two signals at a time, then the most correspondence table can indicate both the inputs of the two signals of the left rod 11 and the inputs of the two signals of the right rod 11.

The “Reserve” in the tables is not marked for any character use and correspondence thereof, and can be arbitrary correspondence if necessary. The table mainly indicates the corresponding method of the twenty six English characters.

The above corresponding representatives mainly correspond to the orientations of the English letters on a common keyboard. If a Chinese character or a character of other languages is needed to be input, the correspondence is based on the corresponding positions on the keyboard between the English letters and these different input characters.

Some input and encode methods when a single rod 11 and two rods 11 are used as a numeral and text input method are illustrated above, other rod input and encode methods based on the same inventive idea such as multiple rods input method and other input arrangement methods for the left and right thumb-controlled rods 11 are all within the scope of the present invention.

The invention has been given by way of example only, and various other modification of and/or alterations to the described embodiment may be made by persons skilled in the art without departing from the scope of the invention as specified in the appended claims.

1. A keypad for a portable electronic device, comprising:
a base,
a first rod extending from the base and configured to be toggled from a middle position into a plurality of deflected positions and to be depressed from any one of the middle and deflected positions,
a plurality of trigger switches provided on the base and configured to be selectively switched in accordance with the toggled position of the rod to thereby output a corresponding electrical signal to be processed by the portable electronic device.

2. The keypad as claimed in claim 1, wherein the plurality of trigger switches comprises eight trigger switches corresponding in position to eight deflected positions of the first rod.

3. The keypad as claimed in claim 2, wherein the eight trigger switches are uniformly distributed about the first rod, and the base further comprises a ninth trigger switch beneath the first rod that is activated upon depression of the rod from any one of the middle and deflected positions.

4. The keypad as claimed in claim 1, wherein the trigger switches are touch-sensitive switches.

5. The keypad as claimed in claim 1, wherein the trigger switches are inductive switches.

6. The keypad as claimed in claim 1, wherein the trigger switches are photoelectric switches.

7. A mobile phone including the keypad of claim 1.

8. A PDA including the keypad of claim 1.

9. An input method using the keypad as claimed in claim 2, for generating seventeen different signals corresponding to each of seventeen different positions of the first rod.

10. The input method as claimed in claim 9, wherein the keypad base comprises a second rod and corresponding set of switches, for generating at least thirty four different signals, upon individual manipulation of the first and second rods or combined manipulation of the first and second rods, to generate different numerals, letters, or radicals of Chinese characters, or other characters or functions.

11. The input method as claimed in claim 10, wherein ten Arabic numerals and some functional keys are indicated by the seventeen different positions of one of the first and second rods.

12. The input method as claimed in claim 11, wherein alphanumeric and functional keys correspond to the different actions of the first and second rods in the following manner, in which X indicates that there is an inductive signal, and Reserve indicates other characters or functions:

| | | | | middle | | | | | |
|---|---|---|---|---|---|---|---|---|---|
| | | | | (press | | down- | | down- | |
| top-left | top | top-right | left | [symbol] | right | left | down | right | representatives |
| X | | | | | | | | | 1 |
| | X | | | | | | | | 2 |
| | | X | | | | | | | 3 |
| | | | X | | | | | | 4 |
| | | | | X | | | | | 5 |
| | | | | | X | | | | 6 |
| | | | | | | X | | | 7 |
| | | | | | | | X | | 8 |
| | | | | | | | | X | 9 |
| X | | | | X | | | | | Yes (OK) |
| | X | | | X | | | | | Reserve |
| | | X | | X | | | | | No |
| | | | | | | | | | (Cancel) |
| | | | X | X | | | | | Reserve |
| | | | | X | X | | | | Reserve |
| | | | | X | | X | | | Reserve |
| | | | | X | | | X | | 0 |
| | | | | X | | | | X | Reserve |

[symbol]

indicates data missing or illegible when filed

13. The input method as claimed in claim 10, wherein a plurality of alphanumeric characters and some functional keys are indicated by the seventeen different signal outputs of one of the first and second rods, and the seventeen different signals are encoded according to the positions of the alphanumeric characters on a normal keyboard and the correspondence between the toggled directions of one of the first and second rods and the positions.

14. The input method as claimed in claim 10, wherein a plurality of alphanumeric characters and some functional keys are indicated by the thirty four different signal outputs of the first and second rods, and the thirty four different signals are encoded according to the positions of the alphanumeric characters on a normal keyboard and correspondence between the toggling directions of one of the first and second rods and the positions.

15. The input method as claimed in claim 13, wherein the alphanumeric characters and functional keys correspond to the different actions of the first and second rods in the following manner, in which X indicates that there is an inductive signal, and Reserve indicates other characters or functions:

| | | | | middle | | | | | | | | | [symbol] | | | | | |
|---|---|---|---|---|---|---|---|---|---|---|---|---|---|---|---|---|---|---|
| top- | | top- | | (press | | down- | | down- | | | | | (press | | down- | | down- | repre- |
| left | top | right | left | down) | right | left | down | right | top-left | top | top-right | left | [symbol] | right | [symbol] | down | right | sentatives |
| X | | | | | | | | | | | | | | | | | | w |
| | X | | | | | | | | | | | | | | | | | e |
| | | X | | | | | | | | | | | | | | | | r |
| | | | X | | | | | | | | | | | | | | | s |
| | | | | X | | | | | | | | | | | | | | d |
| | | | | | X | | | | | | | | | | | | | f |
| | | | | | | X | | | | | | | | | | | | x |
| | | | | | | | X | | | | | | | | | | | c |
| | | | | | | | | X | | | | | | | | | | v |
| X | | | | X | | | | | | | | | | | | | | q |
| | X | | | X | | | | | | | | | | | | | | Reserve |
| | | X | | X | | | | | | | | | | | | | | t |
| | | | X | X | | | | | | | | | | | | | | a |
| | | | | X | X | | | | | | | | | | | | | g |
| | | | | X | | X | | | | | | | | | | | | z |
| | | | | X | | | X | | | | | | | | | | | Reserve |
| | | | | X | | | | X | | | | | | | | | | b |
| | | | | | | | | | X | | | | | | | | | u |
| | | | | | | | | | | X | | | | | | | | i |
| | | | | | | | | | | | X | | | | | | | o |
| | | | | | | | | | | | | X | | | | | | j |
| | | | | | | | | | | | | | X | | | | | k |
| | | | | | | | | | | | | | | X | | | | l |
| | | | | | | | | | | | | | | | X | | | m |
| | | | | | | | | | | | | | | | | X | | Reserve |
| | | | | | | | | | | | | | | | | | X | Reserve |
| | | | | | | | | | X | | | | X | | | | | y |
| | | | | | | | | | | X | | | X | | | | | Reserve |
| | | | | | | | | | | | X | | X | | | | | p |
| | | | | | | | | | | | | X | X | | | | | h |
| | | | | | | | | | | | | | X | X | | | | Reserve |
| | | | | | | | | | | | | | X | | X | | | n |
| | | | | | | | | | | | | | X | | | X | | Reserve |
| | | | | | | | | | | | | | X | | | | X | Reserve |
| X | | | | | | | | | | | | | X | | | | | W |
| | X | | | | | | | | | | | | X | | | | | E |
| | | X | | | | | | | | | | | X | | | | | R |
| | | | X | | | | | | | | | | X | | | | | S |
| | | | | X | | | | | | | | | X | | | | | D |
| | | | | | X | | | | | | | | X | | | | | F |
| | | | | | | X | | | | | | | X | | | | | X |
| | | | | | | | X | | | | | | X | | | | | C |
| | | | | | | | | X | | | | | X | | | | | V |
| X | | | | X | | | | | | | | | X | | | | | Q |
| | X | | | X | | | | | | | | | X | | | | | Reserve |
| | | X | | X | | | | | | | | | X | | | | | T |
| | | | X | X | | | | | | | | | X | | | | | A |
| | | | | X | X | | | | | | | | X | | | | | G |
| | | | | X | | X | | | | | | | X | | | | | Z |
| | | | | X | | | X | | | | | | X | | | | | Reserve |
| | | | | X | | | | X | | | | | X | | | | | B |
| | | | | X | | | | | X | | | | | | | | | U |
| | | | | X | | | | | | X | | | | | | | | I |
| | | | | X | | | | | | | X | | | | | | | O |
| | | | | X | | | | | | | | X | | | | | | J |
| | | | | X | | | | | | | | | X | | | | | K |
| | | | | X | | | | | | | | | | X | | | | L |
| | | | | X | | | | | | | | | | | X | | | M |
| | | | | X | | | | | | | | | | | | X | | Reserve |
| | | | | X | | | | | | | | | | | | | X | Reserve |
| | | | | X | | | | | X | | | | X | | | | | Y |
| | | | | X | | | | | | X | | | X | | | | | Reserve |
| | | | | X | | | | | | | X | | X | | | | | P |
| | | | | X | | | | | | | | X | X | | | | | H |
| | | | | X | | | | | | | | | X | X | | | | Reserve |
| | | | | X | | | | | | | | | X | | X | | | N |
| | | | | X | | | | | | | | | X | | | X | | Reserve |
| | | | | X | | | | | | | | | X | | | | X | Reserve |

[symbol]

indicates data missing or illegible when filed

16. The input method as claimed in claim 10, wherein a plurality of Chinese characters or characters of other languages and some functions are indicated by the thirty four different signal outputs of the first and second rods, and the thirty four different signals are encoded based on corresponding positions between characters and alphanumeric characters, according to the positions of the alphanumeric characters on a normal keyboard and correspondence between the toggled directions of one of the first and second rods.
